(19) United States
(12) Patent Application Publication
(10) Pub. No.: US 2005/0159562 A1
(43) Pub. Date: Jul. 21, 2005

(54) Polyaryl ether copolymer, process for the production thereof, and polymer electrolytic film formed of the same

(75) Inventors: Mikiya Hayashi, Ichihara-shi (JP); Yutaka Obata, Ichihara-shi (JP); Toru Bando, Ichihara-shi (JP)

Correspondence Address: PARKHURST & WENDEL, L.L.P., 1421 PRINCE STREET, SUITE 210, ALEXANDRIA, VA, 22314-2805, US

(73) Assignee: Idemitsu Kosan Co., Ltd., Chiyoda-ku (JP)

(21) Appl. No.: 11/036,391

(22) Filed: Jan. 18, 2005

(30) Foreign Application Priority Data
Jan. 16, 2004 (JP) 2004-008817

(51) Int. Cl. C08G 2/00

(52) U.S. Cl. 525/534

(57) ABSTRACT

A polyaryl ether copolymer which has the following formula (1) and contains at least 0.1% by weight of a hydrophilic group,
Ar₁—O—Ar₂—OₙAr₃—O—Ar₄—Oₘ (1)
each of Ar₁ and Ar₃ independently represents a group selected from the following groups, 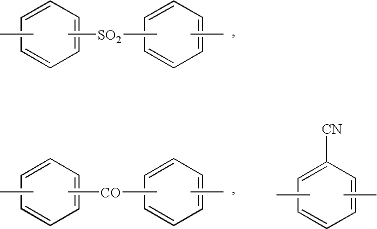
each of Ar₂ and Ar₄ independently represents a group selected from the following groups, 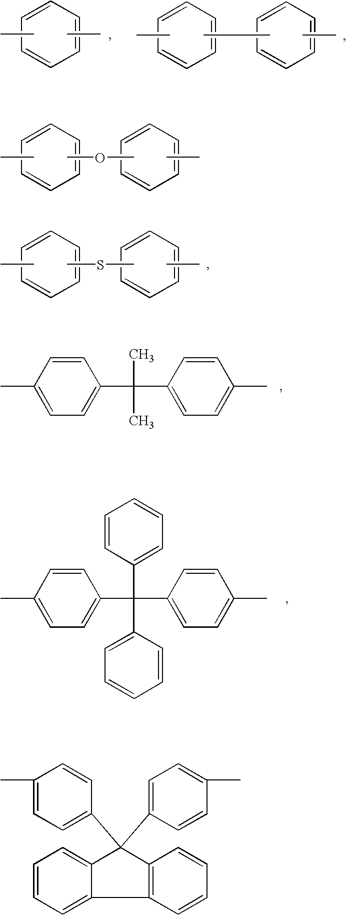
the hydrophilic group is substituted on at least one of Ar₁, Ar₂, Ar₃ and Ar₄, and each of n and m represents a copolymerization compositional ratio.

### BACKGROUND OF THE INVENTION

1. Field of the Invention

The present invention relates to a polyaryl ether copolymer, a process for the production thereof and a polymer electrolytic film formed of the same.

2. Related Art

Perfluorosulfonic-acid-based materials including Nafion (trade name of E. I. du Pont de Nemours and Company) have been and are mainly used as proton-conductive polymer electrolytes for use in solid polymer type fuel cells, since they have excellent properties as fuel cells. However, the above materials are very expensive, which is therefore expected to be a big problem when electricity generation systems using a fuel cell become widely used in the future.

Under the circumstances, less expensive polymer electrolytes that can replace the perfluorosulfonic-acid-based materials are in a vigorous development stage in recent years. Above all, a material created by introducing a sulfonic acid group into an aromatic polyether having excellent heat resistance and high film strength is considered promising. For example, Japanese National Publication No. 11-502249 of Translated Version of PCT describes a polymer electrolyte based on a sulfonated polyether ketone, and JP-A-10-45913 and JP-A-10-21943 describe polymer electrolytes based on sulfonated polyether ketones.

While the proton conductivity of these materials generally increases with an increase in the amount of the introduced sulfonic acid groups, the water absorptivity of the polymer tends to increase at the same time. When a film formed from a polymer having high water absorptivity is used in a fuel cell, the film is caused to have a great change in dimensions due to water formed during the use of the cell, so that the strength of the film decreases.

For overcoming the above problem, JP-A-2001-250567 discloses a block copolymer having segments containing sulfonic acid groups and segments free of sulfonic acid groups, and it is reported that the copolymer has ion conductivity equivalent to, or higher than, that of a random copolymer and has water absorptivity that can be controlled to be small. It is described that the block group includes aromatic polyethers such as polysulfone, and the like.

The synthesis method described in JP-A-2001-250567 is a method in which two types of polymers are separately synthesized and terminals of these polymer components are polycondensed to synthesize the block polymer. However, this method includes complicated steps, and due to the fundamental demand of the polycondensative reaction, a polymer having a high molecular weight is formed only when the molar balance of terminals of the two types of the polymers is well accurately attained. It is therefore required to carry out terminal analysis or to take measure to control a process for the molar balance control, so that the above method is not an industrially useful method. Further, since each polymer has a molecular weight distribution, the block polymer as a condensation product of them has a sequence length distribution, so that it is difficult to carry out accurate group control.

Further, JP-A-2003-31232 discloses an aromatic polyether sulfone block copolymer having a segment containing a sulfonic acid group and a segment free of a sulfonic acid group. However, this literature merely refers to the dependency of the proton conductivity on humidity, and it describes nothing concerning the water absorptivity. Moreover, the block copolymerization method described in this literature is similar to that described in JP-A-2001-250567 and has the above-described problems.

### SUMMARY OF THE INVENTION

It is an object of the present invention to provide a polyaryl ether copolymer having high proton conductivity and low water absorptivity and a polymer electrolytic film formed of the same.

The present inventors have made diligent studies, and as a result, have found that a specific polyaryl ether copolymer has high proton conductivity and low water absorptivity, which has led to the present invention.

According to the present invention, the following polyaryl ether copolymer, and the like are provided.

1. A polyaryl ether copolymer which has the following formula (1) and contains at least 0.1% by weight of a hydrophilic group,
Ar₁—O—Ar₂—OₙAr₃—O—Ar₄—Oₘ (1)
wherein each of Ar₁ and Ar₃ independently represents a group selected from the following groups, 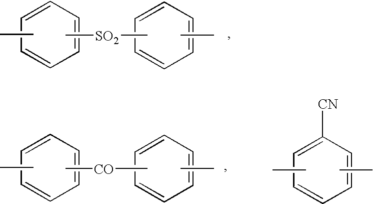
each of Ar₂ and Ar₄ independently represents a group selected from the following groups, 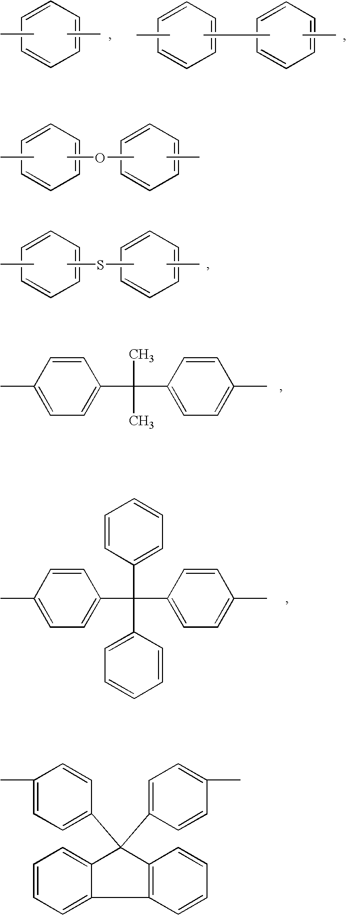
the hydrophilic group is substituted on at least one of Ar₁, Ar₂, Ar₃ and Ar₄, and each of n and m represents a copolymerization compositional ratio.

2. A polyaryl ether copolymer as recited in the above 1, wherein Ar₁ is a cyanophenylene group.

3. A polyaryl ether copolymer as recited in the above 1 or 2, wherein Ar₁ and Ar₃ represent the same groups.

4. A polyaryl ether copolymer as recited in any one of the above 1 to 3, wherein the hydrophilic group is at least one group selected from a sulfonic acid group (—SO₃H), a phosphonic acid group (—PO₃H₂) or a carboxyl group (—COOH).

5. A polyaryl ether copolymer as recited in the above 4, wherein the hydrophilic group is a sulfonic acid group (—SO₃H).

6. A polyaryl ether copolymer as recited in any one of the above 1 to 5, which is a random copolymer.

7. A polyaryl ether copolymer as recited in any one of the above 1 to 5, which is a block copolymer.

8. A process for the production of the polyaryl ether copolymer recited in any one of the above 1 to 7, which comprises copolymerizing X—Ar₁—X, HO—Ar₂—OH, X—Ar₃—X and HO—Ar₄—OH, in which X is a halogen, Ar₁, Ar₂, Ar₃ and Ar₄ are as defined above, and a hydrophilic group is substituted on at least one of Ar₁, Ar₂, Ar₃ and Ar₄.

9. A process for the production of a polyaryl ether random copolymer recited in the above 3, which comprises reacting X—Ar₁—X, HO—Ar₂—OH and HO—Ar₄—OH, in which X is a halogen, Ar₁, Ar₂ and Ar₄ are as defined above, and a hydrophilic group is substituted on at least one of Arl, Ar₂ and Ar₄.

10. A process for the production of a polyaryl ether block copolymer recited in the above 3, which comprises reacting X—Ar₁—X and HO—Ar₄—OH to produce a polymer and adding the polymer when X—Ar₁—X, HO—Ar₂—OH and HO—Ar₄—OH are reacted to form a random copolymer, in which X is a halogen, Ar₁, Ar₂ and Ar₄ are as defined above, and a hydrophilic group is substituted on at least one of Ar₁, Ar₂ and Ar₄.

11. A polymer electrolytic film formed of the polyaryl ether copolymer recited in any one of the above 1 to 7.

12. An electrode material formed of the polyaryl ether copolymer recited in any one of the above 1 to 7.

13. A fuel cell comprising the polymer electrolytic film recited in the above 11 and/or the electrode material recited in the above 12.

According to the present invention, there can be obtained a polyaryl ether copolymer having high proton conductivity and low water absorption and a polymer electrolytic film formed of the same.

According to the present invention, further, there can be provided a process for the production of a polyaryl ether copolymer, which process is industrially easy and permits the control of groups.

### DESCRIPTION OF THE PREFERRED EMBODIMENTS

The polyaryl ether copolymer of the present invention is a copolymer of the formula (1).
Ar₁—O—Ar₂—OₙAr₃—O—Ar₄—Oₘ (1)

The copolymer contains at least 0.1% by weight, preferably 1 to 30% by weight, more preferably 2 to 25% by weight, of a hydrophilic group substituted on at least one of Ar₁, Ar₂, Ar₃ and Ar₄.

The weight average molecular weight and the copolymerization compositional ratios n and m of the polyaryl ether copolymer of the present invention are adjusted such that a predetermined amount of the hydrophilic group is contained, while the weight average molecular weight is generally 50,000 to 200,000.

In the above formula (1), each of Ar₁ and Ar₃ may be the same as, or different from, other and is a group selected from the following groups, 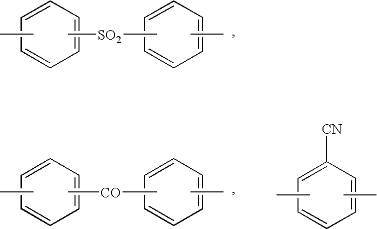
and it is more preferably a group selected from the following groups.

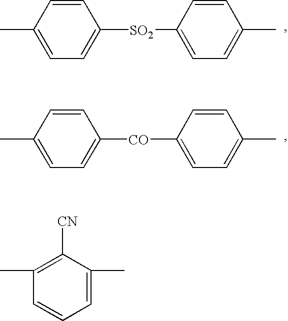

In the above formula (1), each of Ar₂ and Ar₄ may be the same as, or different from, other and is a group selected from the following groups, 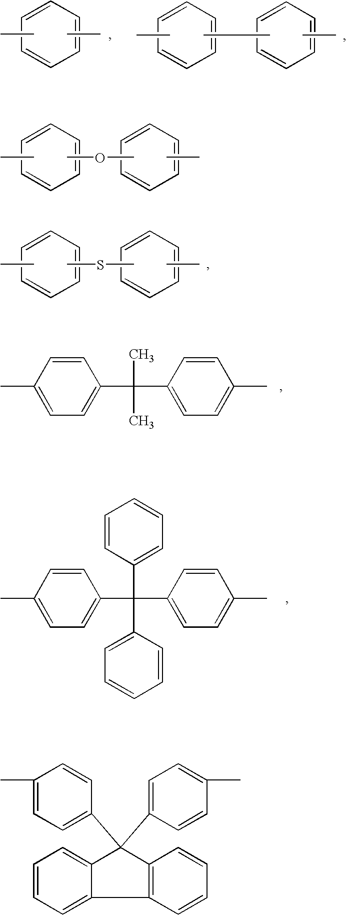
and it is more preferably a group selected from the following groups.

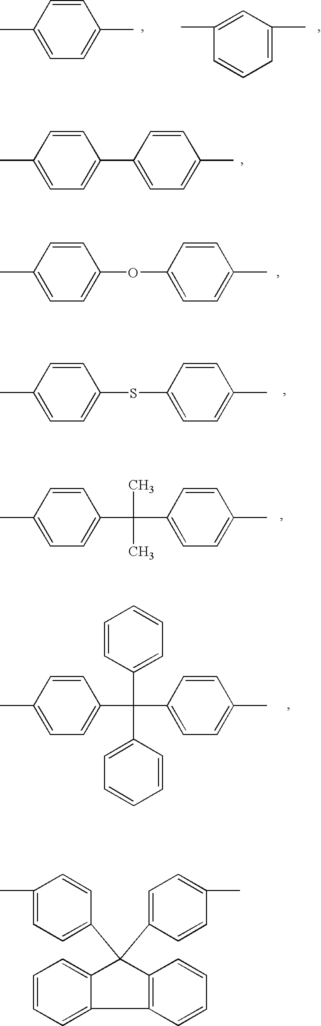

As described above, a hydrophilic group is substituted on at least one of Ar₁, Ar₂, Ar₃ and Ar₄. When the hydrophilic group is substituted, for example, on Ar₂, examples of such a group include the following groups, 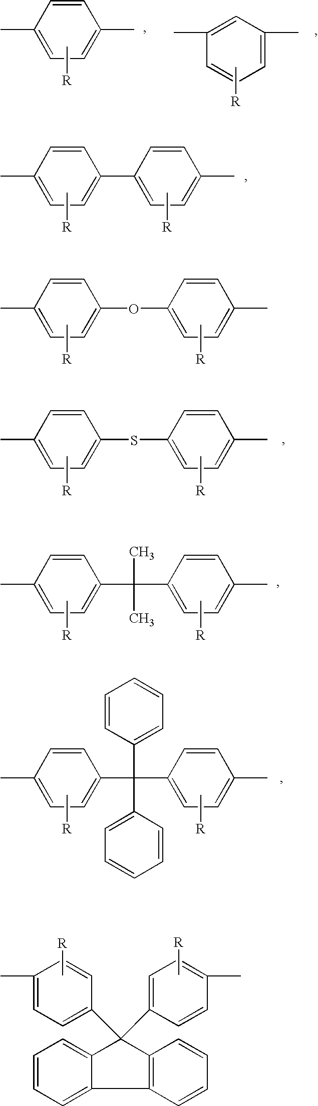
wherein R is a hydrophilic group, provided that when two Rs are substituted, the Rs may be the same as, or different from, each other.

Examples of the hydrophilic group include a sulfonic acid group (—SO₃H), a phosphonic acid group (—PO₃H₂) or a carboxyl group (—COOH). A sulfonic acid group (—SO₃H) is preferred.

The copolymer of the present invention may be any one of a block copolymer and a random copolymer. However, when they have equivalent film resistances, a block copolymer is preferred since the block copolymer has low water content and is excellent in dimensional stability, water resistance and gas-barrier properties.

The process for the production of a polyaryl ether copolymer of the present invention will be explained below.

The copolymer of the present invention can be produced by using X—Ar₁—X, HO—Ar₂—OH, X—Ar₃—X and HO—Ar₄—OH, in which X is a halogen, Ar₁, Ar₂, Ar₃ and Ar₄ are as defined above, and the hydrophilic group is substituted on at least one of Ar₁, Ar₂, Ar₃ and Ar₄ (these definitions apply to explanations to be given hereinafter).

That is, the copolymer is generally synthesized from dihydric phenols and aromatic dihalogen compounds having an electron-attracting group on the o- or p-position. Of the dihydric phenols and the aromatic dihalogen compounds, one or more dihydric phenols and one or more aromatic dihalogen compounds may be used. At least one compound of the dihydric phenols and aromatic dihalogen compounds has the hydrophilic group.

Examples of the dihydric phenols containing the hydrophilic group include HO—Ar₂—OH in which Ar₂ is as defined above and substituted with the hydrophilic group. Specific examples thereof include 2,5-dihydroxybenzenesulfonic acid, 2,5-dihdyroxy-1,4-benzenedisulfonic acid, 4,5-dihdyroxy-1,3-benzenesulfonic acid, 4,4′-dihydroxy-2,2′-disulfonic acid-1,1′-biphenyl.

Examples of the dihalogen compound containing the hydrophilic group include X—Ar₁—X, in which X is a halogen and Ar₁ is as defined above and is substituted with the hydrophilic group. Specific examples thereof include 5,5-carbonylbis(2-fluorobenzenesulfonic acid), 5,5-sulfonylbis(2-fluorobenzenesulfonic acid), 5,5-carbonylbis(2-chlorobenzenesulfonic acid) and 5,5-sulfonylbis(2-fluorobenzenesulfonic acid).

The dihydric phenols free of any hydrophilic group include those which are the same as the above dihydric phenols containing the hydrophilic group but are not substituted with any hydrophilic group. Specifically, the dihydric phenols free of any hydrophilic group include bisphenol A, bis(4-hydroxyphenyl)diphenylmethane, 4,4′-dihydroxybiphenyl and 9,9-bis(4-hydroxyphenyl)fluorene.

The dihalogen compounds free of any hydrophilic group include those which are the same as the above dihalogen compounds containing the hydrophilic group but are not substituted with any hydrophilic group. Specifically, the dihalogen compound free of any hydrophilic group include 2,6-difluorobenzonitrile, 4,4′-difluorodiphenylsulfone, 4,4′-dichlorodiphenylsulfone, 4,4′-difluorobenzophenone, 4,4′-dichlorobenzophenone and 2,6-dichlorobenzonitrile.

While the hydrophilic group is a sulfonic acid group in all of the above examples, there may be also used those which are the same as the above examples but have a phosphonic acid group or a carboxyl group in place of the sulfonic acid group.

While the amount of the monomer containing the hydrophilic group is not critical, the monomer containing the hydrophilic group is added in such an amount that the copolymer to be obtained can contain the above-described weight % of the hydrophilic group. Generally, since the content of the hydrophilic group in the polymer is an important factor that determines the proton conductivity, it can be used in an amount that is in accord with the desired proton conductivity.

The solvent for use in the polymerization is preferably selected from aprotic polar solvents such as N-methyl-2-pyrrolidone (NMP), 1,3-dimethyl-imidazolidinone (DMI), dimethyl sulfoxide (DMSO), dimethylformamide(DMF), dimethylacetamide (DMAc) and the like, and NMP and DMI are more preferred.

The reaction temperature is preferably 150 to 250° C., more preferably 170° C. to 220° C. When it is too low, the reaction rate may decrease. When it is too high, a side reaction such as decomposition may occur.

In the synthesis of a general wholly aromatic polyether, an alkali metal compound is added. It works to convert the above dihydric phenols into alkali metal salts. Carbonate, hydrogen carbonate or hydroxide of alkali metal is suitably used. These alkali metal salts may be used singly or in combination of two or more members of them without any problem.

When the copolymer of the present invention is a random copolymer, for example, the random copolymer can be produced by the following method.

X—Ar₁—X, HO—Ar₂—OH, X—Ar₃—X and HO—Ar₄—OH are reacted and random-copolymerized.

When X—Ar₁—X and X—Ar₃—X are identical, X—Ar₁—X, HO—Ar₂—OH and HO—Ar₄—OH can be reacted for the production.

When the copolymer of the present invention is a block copolymer, for example, the copolymer can be produced by the following method.

X—Ar₁—X and HO—Ar₂—OH are reacted to produce a polymer I having a recurring unit of the following formula (2).
Ar₁—O—Ar₂O (2)

X—Ar₃—X and HO—Ar₄—OH are reacted to produce a polymer II having a recurring unit of the following formula (3).
Ar₃—O—Ar₄—O (3)

Then, the polymer I and the polymer II are block-copolymerized.

The block copolymer can be also produced as an AB block polymer by allowing a polyester B to be co-present when a polyether A is synthesized.

For example, when the polyether A is a “polyether containing the hydrophilic group” and when the polyether B is a “polyether free of any hydrophilic group”, the “polyether free of any hydrophilic group” is added to the polymerization field of the “polyether containing the hydrophilic group” or, alternatively, the “polyether containing the hydrophilic group” is added to the polymerization field of the “polyether free of any hydrophilic group”, whereby a block polymer having a sequence containing the hydrophilic group and a sequence free of any hydrophilic group is synthesized. In this case, it can be decided depending upon a purpose which procedure should be selected, and the selection is not essential for the present invention.

The time of the addition to the polymerization field influences on the sequence length of a block copolymer to be obtained. That is, as the time of the addition is deferred, the molecular weight of the polymer to be synthesized in the polymerization field increases, and as a result, the block copolymer obtained thereafter have a longer sequence. It is a big feature of the above method that the sequence length can be controlled on the basis of the time of the addition. Thus a desired sequence length can be obtained by properly selecting the time of the addition.

Like the above time of the addition, the molecular weight of the polymer added influences on the sequence length of a block copolymer to be obtained. That is, with an increase in the molecular weight of the polymer added, the sequence length of the block copolymer increases. Therefore, a desired sequence length can be obtained as well by properly selecting the molecular weight.

In the above production method, the copolymerization is carried out after the hydrophilic group is incorporated into the monomer. However, there may be employed a method in which a copolymer is produced from monomers free of any hydrophilic group as described above, and the hydrophilic group is then incorporated into the copolymer.

The method for forming a polymer electrolytic film for a polymer electrolyte fuel cell from the above polyaryl ether copolymer is not specially limited. For example, the polyaryl ether copolymer is dissolved in a polar solvent such as dimethyl sulfoxide, sulfolane, N-methyl-2-pyrrolidone, 1,3-dimethyl-2-imidazolidinone, N,N-dimethylformamide, N,N-dimethylacetamide, diphenyl sulfone, the resultant solution is cast on a support, and the polar solvent is removed by volatilization, to form the film. The above film generally has a thickness of 5 to 200 μm, preferably 10 to 150 μm.

If necessary, the polyaryl ether copolymer of the polymer electrolytic film of the present invention may have sulfonic acid groups some of which are converted to metal salts so long as it does not impair the features of the present invention. The polymer electrolytic film may be reinforced with a fiber, a porous film, or the like. The polyaryl ether copolymer may be optionally blended with an inorganic acid such as phosphoric acid, hypophosphorous acid or a sulfuric acid or a salt thereof, a perfluoroalkylsulfonic acid having 1 to 14 carbon atoms or a salt thereof, a perfluoroalkylcarboxylic acid having 1 to 14 carbon atoms or a salt thereof, an inorganic substance such as platinum, silica gel, silica or zeolite, or the other polymer. When the electrolyte of the present invention is produced, there may be used additives such as a plasticizer, a stabilizer, a mold release agent, etc., which are used in general polymers, unless contrary to the object of the present invention. Furthermore, when the electrolyte of the present invention is produced or when the electrolyte is processed or molded to form a film, etc., an intermolecular crosslinkage structure may be introduced unless contrary to the object of the present invention.

The method for producing a fuel cell or membrane/electrode assembly (MEA) using the above polymer electrolytic film is not specially limited, and they can be produced by a known method. Generally, electrodes are adhered to the polymer electrolytic film to form a MEA. The MEA is sandwiched with gaskets and separators to form a cell (minimum electric generator). A plurality of such cells are arranged to constitute a fuel cell. A MEA is produced, for example, by holding the polymer electrolytic films with electrodes. The electrode for use in the MEA can be prepared by dispersing a metal in an electrode material that is the same as, or similar to, that of the polymer electrolytic film. Further, MEA can be produced by a method in which a gas diffusion electrode having, as a catalyst, platinum, a platinum-ruthenium alloy, a platinum-tin ally or fine particles thereof dispersed and supported on a support such as carbon is formed directly on the polymer electrolytic film, a method in which the gas diffusion electrode and the polymer electrolytic film are hot-pressed, a method in which they are bonded with an adhesive liquid, or other method.

The polyaryl ether copolymer of the present invention has high proton conductivity and low water absorptivity, so that it can be suitably used as a polymer electrolytic film in a fuel cell or the like. The fuel cell is used in an automobile, cogeneration, a personal computer, or the like.

### EXAMPLES

[Synthesis of Random Copolymer]

### Example 1

A 100-ml four-necked separable flask equipped with a “Three-one motor” stirrer, a nitrogen gas introducing tube, a thermocouple and a “Dean and Stark trap” charged with toluene was charged with 5.085 g (0.02 mol) of 4,4′-difluorodiphenyl sulfone, 2.283 g (0.01 mol) of potassium 2,5-dihydroxybenzenesulfonate, 2.283 g (0.01 mol) of bisphenol A and 3.317 g (0.024 mol) of potassium carbonate. Thereto was added 50 ml of N-methyl-2-pyrrolidone fully degassed with nitrogen, and in a nitrogen gas current, the mixture was temperature-increased up to 195° C. in an oil bath with stirring. After the internal temperature reached 195° C., several ml of toluene was added to the system, and byproduced water was distilled out of the system under conditions of toluene refluxing for 1 hour. Then, the system was temperature-increased up to 200° C. and allowed to react for 3 hours.

After completion of the reaction, the reaction mixture was cooled to room temperature, and then poured into a large amount of a hydrochloric acid aqueous solution (0.1 N) to precipitate a polymer. The precipitated polymer was pulverized with a blender, and the pulverized product was repeatedly washed with water and filtered four or five times to purify the product. Then, the product was vacuum-dried at 80° C. for one day and night to give a random copolymer of the following formula (A), in which n and m are copolymerization compositional ratios.

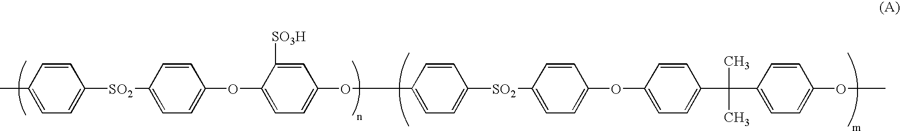

The thus-obtained random copolymer was measured for a molecular weight by the following method.

Apparatus: GPC, temperature: 60° C., detector: RI, solvent: NMP

IR was measured according to FT-IR. As a result, the random copolymer had a molecular weight of 154,000, and its IR peaks were as follows. In the following examples, molecular weights and IR were measured by the same method.

1,160, 1,390 cm⁻¹ (SO₃H)

### Example 2

A random copolymer of the above formula (A) was obtained in the same manner as in Example 1 except that the amount of potassium 2,5-dihydroxybenzenesulfonate was changed from 2.283 g (0.01 mol) to 3.424 g (0.015 mol) and that the amount of bisphenol A was changed from 2.283 g (0.01 mol) to 1.142 g (0.005 mol).

The thus-obtained random copolymer had a molecular weight of 142,000, and its IR peaks were as follows.

1,160, 1,390 cm⁻¹ (SO₃H)

### Example 3

A random copolymer of the following formula (B), in which n and m are copolymerization compositional ratios, was obtained by carrying out a reaction in the same manner as in Example 1 except that the raw materials in Example 1 were replaced with 5.085 g (0.02 mol) of 4,4′-difluorodiphenylsulfone, 3.059 g (0.0134 mol) of potassium 2,5-dihydroxybenzenesulfonate, 2.326 g (0.0066 mol) of bis(4-hydroxyphenyl)diphenylmethane and 3.317 g (0.024 mol) of potassium carbonate.

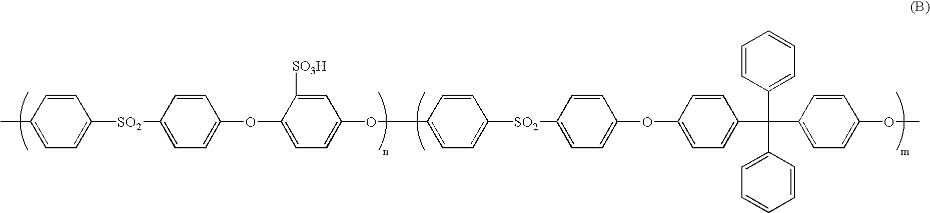

The thus-obtained random copolymer had a molecular weight of 158,000, and its IR peaks were as follows.

1,160, 1,390 cm⁻¹ (SO₃H)

### Example 4

A random copolymer of the following formula (C), in which n and m are copolymerization compositional ratios, was obtained by carrying out a reaction in the same manner as in Example 1 except that the raw materials in Example 1 were replaced with 2.782 g (0.02 mol) of 2,6-difluorobenzonitrile, 3.059 g (0.0134 mol) of potassium 2,5-dihydroxybenzenesulfonate, 1.507 g (0.0066 mol) of bisphenol A and 2.544 g (0.024 mol) of sodium carbonate.

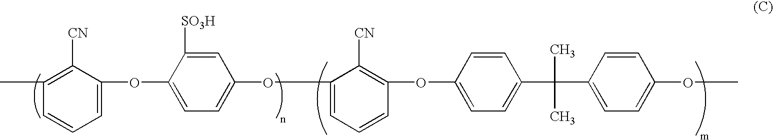

The thus-obtained random copolymer had a molecular weight of 135,000, and its IR peaks were as follows.

1,160, 1,390 cm⁻¹ (SO₃H), 2,250 cm⁻¹ (CN)

### Example 5

A random copolymer of the following formula (D), in which n and m are copolymerization compositional ratios, was obtained by carrying out a reaction in the same manner as in Example 1 except that the raw materials in Example 1 were replaced with 2.782 g (0.02 mol) of 2,6-difluorobenzonitrile, 3.059 g (0.0134 mol) of potassium 2,5-dihydroxybenzenesulfonate, 2.326 g (0.0066 mol) of bis(4-hydroxyphenyl)diphenylmethane and 2.544 g (0.024 mol) of sodium carbonate.

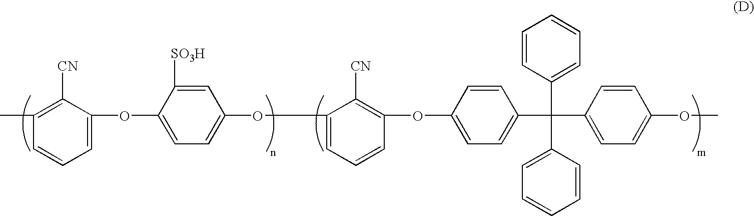

The thus-obtained random copolymer had a molecular weight of 122,000, and its IR peaks were as follows.

1,160, 1,390 cm⁻¹ (SO₃H), 2,250 cm⁻¹ (CN)

### Example 6

A random copolymer of the following formula (E), in which n and m are copolymerization compositional ratios, was obtained by carrying out a reaction in the same manner as in Example 1 except that the raw materials in Example 1 were replaced with 2.782 g (0.02 mol) of 2,6-difluorobenzonitrile, 3.059 g (0.0134 mol) of potassium 2,5-dihydroxybehzenesulfonate, 1.229 g (0.0066 mol) of 4,4′-dihydroxybiphenyl and 2.544 g (0.024 mol) of sodium carbonate.

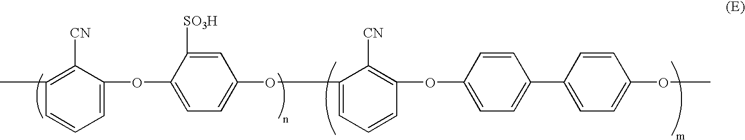

The thus-obtained random copolymer had a molecular weight of 128,000, and its IR peaks were as follows.

1,160, 1,390 cm⁻¹ (SO₃H), 2,250 cm⁻¹ (CN)

### Example 7

A random copolymer of the following formula (F), in which n and m are copolymerization compositional ratios, was obtained by carrying out a reaction in the same manner as in Example 1 except that the raw materials in Example 1 were replaced with 4.364 g (0.02 mol) of 4,4′-difluorobenzophenone, 3.059 g (0.0134 mol) of potassium 2,5-dihydroxybenzenesulfonate, 1.507 g (0.0066 mol) of bisphenol A and 3.317 g (0.024 mol) of potassium carbonate.

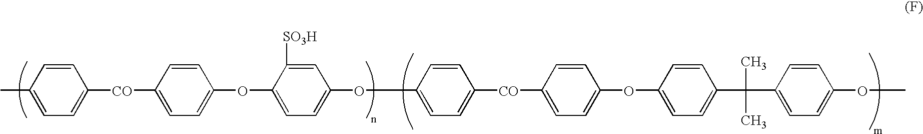

### Example 8

A random copolymer of the following formula (G), in which n and m are copolymerization compositional ratios, was obtained by carrying out a reaction in the same manner as in Example 1 except that the raw materials in Example 1 were replaced with 5.085 g (0.02 mol) of 4,4′-difluorodiphenylsulfone, 2.771 g (0.008 mol) of 4,4′-dihydroxy-2,2′-disulfonic acid-1,1′-biphenyl, 2.235 g (0.012 mol) of 4,4′-dihydroxybiphenyl and 3.317 g (0.024 mol) of potassium carbonate.

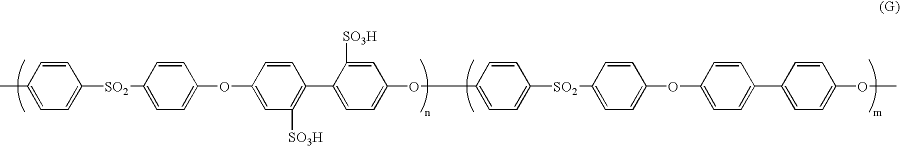

The thus-obtained random copolymer had a molecular weight of 77,300, and its IR peaks were as follows.

1,160, 1,390 cm⁻¹ (SO₃H)

### Example 9

A random copolymer of the following formula (H), in which n and m are copolymerization compositional ratios, was obtained by carrying out a reaction in the same manner as in Example 1 except that the raw materials in Example 1 were replaced with 2.782 g (0.02 mol) of 2,6-difluorobenzonitrile, 2.771 g (0.008 mol) of 4,4′-dihydroxy-2,2′-disulfonic acid-1,1′-biphenyl, 2.235 g (0.012 mol) of 4,4′-dihydroxybiphenyl and 2.544 g (0.024 mol) of sodium carbonate.

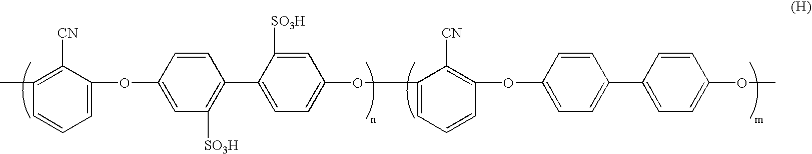

The thus-obtained random copolymer had a molecular weight of 62,900, and its IR peaks were as follows.

1,160, 1,390 cm⁻¹ (SO₃H), 2,250 cm⁻¹ (CN)

### Example 10

A random copolymer of the following formula (I), in which n and m are copolymerization compositional ratios, was obtained by carrying out a reaction in the same manner as in Example 1 except that the raw materials in Example 1 were replaced with 5.085 g (0.02 mol) of 4,4′-difluorodiphenylsulfone, 2.771 g (0.008 mol) of 4,4′-dihydroxy-2,2′-disulfonic acid-1,1′-biphenyl, 4.206 g (0.012 mol) of 9,9-bis(4-hydroxyphenyl)fluorene and 3.317 g (0.024 mol) of potassium carbonate.

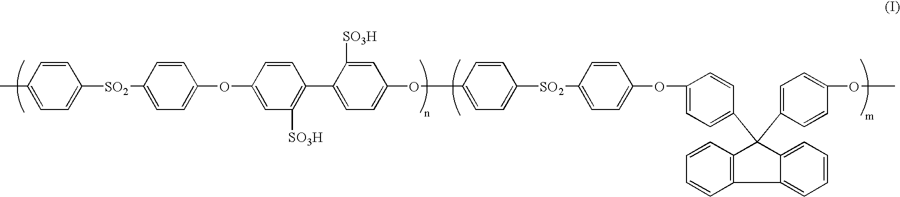

The thus-obtained random copolymer had a molecular weight of 101,000, and its IR peaks were as follows.

1,160, 1,390 cm⁻¹ (SO₃H)

[Synthesis of Block Copolymer]

### Example 11

(1) Synthesis of Homopolymer

A 100-ml four-necked separable flask equipped with a “Three-one motor” stirrer, a nitrogen gas introducing tube, a thermocouple and a “Dean and Stark trap” charged with toluene was charged with 5.034 g (0.0198 mol) of 4,4′-difluorodiphenyl sulfone, 4.566 g (0.02 mol) of bisphenol A and 3.317 g (0.024 mol) of potassium carbonate. Thereto was added 50 ml of N-methyl-2-pyrrolidone fully degassed with nitrogen, and in a nitrogen gas current, the mixture was temperature-increased up to 195° C. in an oil bath with stirring. After the internal temperature reached 195° C., several ml of toluene was added to the system, and byproduced water was distilled out of the system under conditions of toluene refluxing for 1 hour. Then, the system was temperature-increased up to 200° C. and allowed to react for 3 hours.

After completion of the reaction, the reaction mixture was cooled to room temperature, and then poured into a large amount of a hydrochloric acid aqueous solution (0.1 N) to precipitate a polymer. The precipitated polymer was pulverized with a blender, and the pulverized product was repeatedly washed with water and filtered four or five times to purify the product. Then, the product was vacuum-dried at 80° C. for one day and night to give a copolymer having the following recurring unit (a).

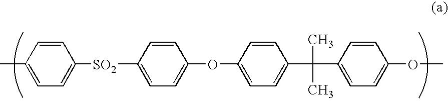

(2) Synthesis of Block Copolymer

A 100-ml four-necked separable flask equipped with a “Three-one motor” stirrer, a nitrogen gas introducing tube, a thermocouple and a “Dean and Stark trap” charged with toluene was charged with 5.085 g (0.02 mol) of 4,4′-difluorodiphenyl sulfone, 2.739 g (0.012 mol) of potassium 2,5-dihydroxybenzenesulfonate, 1.826 g (0.008 mol) of bisphenol A and 3.317 g (0.024 mol) of potassium carbonate. Thereto was added 50 ml of N-methyl-2-pyrrolidone fully degassed with nitrogen, and in a nitrogen gas current, the mixture was temperature-increased up to 195° C. in an oil bath with stirring. After the internal temperature reached 195° C., several ml of toluene was added to the system, and byproduced water was distilled out of the system under conditions of toluene refluxing for 1 hour. Then, the system was temperature-increased up to 200° C. and allowed to react for 3 hours.

The internal temperature was once decreased to 100° C., 1.77 g (0.004 mol) of the polymer synthesized in the above (1) was added, and the mixture was again temperature-increased up to 200° C. and allowed to undergo a block copolymerization reaction over 2 hours.

After completion of the reaction, the reaction mixture was cooled to room temperature, and then poured into a large amount of a hydrochloric acid aqueous solution (0.1 N) to precipitate a polymer. The precipitated polymer was pulverized with a blender, and the pulverized product was repeatedly washed with water and filtered four or five times to purify the product. Then, the product was vacuum-dried at 80° C. for one day and night to give a block copolymer having the above formula (A).

The thus-obtained block copolymer had a molecular weight of 138,000, and its IR peaks were as follows.

1,160, 1,390 cm⁻¹ (SO₃H)

The obtained block copolymer film was measured for a distribution of sulfonic acid groups with EPMA (electron power microanalyzer), to show a non-uniform distribution thereof while a random copolymer had a uniform distribution thereof, and domains of approximately 1 to 2 μm were observed.

On the basis of these facts, it was concluded that the polymer obtained in Example 11 was a block copolymer.

### Example 12

(1) Synthesis of Homopolymer

A polymer having the following recurring unit (b) was obtained by carrying out a reaction in the same manner as in Example 11(l) except that 4.566 g (0.02 mol) of bisphenol A was replaced with 7.049 g (0.02 mol) of bis(4-hydroxyphenyl)diphenylmethane.

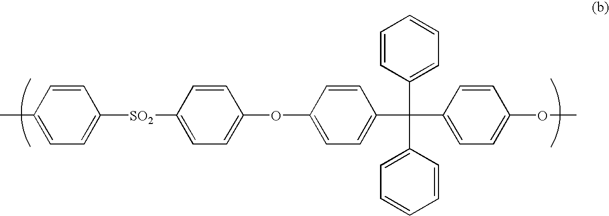

(2) Synthesis of Block Copolymer

A block copolymer of the above formula (B) was obtained by carrying out a reaction and post treatment in the same manner as in Example 11(2) except that the raw materials in Example 11(2) were replaced with 5.085 g (0.02 mol) of 4,4′-difluorodiphenyl sulfone, 3.424 g (0.015 mol) of potassium 2,5-dihydroxybenzenesulfonate, 1.762 g (0.005 mol) of bis(4-hydroxyphenyl)diphenylmethane and 3.317 g (0.024 mol) of potassium carbonate and that the polymer added in the copolymerization was replaced with 1.42 g (0.0025 mol) of the polymer obtained in Example 12(1).

The thus-obtained block copolymer had a molecular weight of 152,000, and its IR peaks were as follows.

1,160, 1,390 cm⁻¹ (SO₃H)

### Example 13

(1) Synthesis of Homopolymer

A polymer having the following recurring unit (c) was obtained by carrying out a reaction in the same manner as in Example 11(1) except that 5.034 g (0.0198 mol) of 4,4′-difluorodiphenyl sulfone was replaced with 2.754 g (0.019 mol) of 2,6-difluorobenzonitrile and that 3.317 g (0.024 mol) of potassium carbonate was replaced with 2.544 g (0.024 mol) of sodium carbonate.

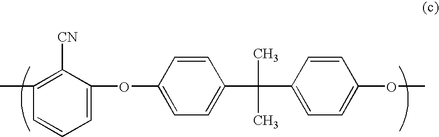

(2) Synthesis of Block Copolymer

A block copolymer of the above formula (C) was obtained by carrying out a reaction and post treatment in the same manner as in Example 11(2) except that the raw materials in Example 11(2) were replaced with 2.782 g (0.02 mol) of 2,6-difluorobenzonitrile, 3.424 g (0.015 mol) of potassium 2,5-dihydroxybenzenesulfonate, 1.142 g (0.005 mol) of bisphenol A and 2.544 g (0.024 mol) of sodium carbonate and that the polymer added in the copolymerization was replaced with 0.82 g (0.0025 mol) of the polymer obtained in Example 13(1).

The thus-obtained block copolymer had a molecular weight of 95,000, and its IR peaks were as follows.

1,160, 1,390 cm⁻¹ (SO₃H), 2,250 cm⁻¹ (CN)

### Example 14

(1) Synthesis of Homopolymer

A polymer having the following recurring unit (d) was obtained by carrying out a reaction in the same manner as in Example 11(1) except that 5.034 g (0.0198 mol) of 4,4′-difluorodiphenyl sulfone was replaced with 2.754 g (0.0198 mol) of 2,6-difluorobenzonitrile, that 4.566 g (0.02 mol) of bisphenol A was replaced with 7.049 g (0.02 mol) of bis(4-hydroxyphenyl)diphenylmethane and further that 3.317 g (0.024 mol) of potassium carbonate was replaced with 2.544 g (0.024 mol) of sodium carbonate.

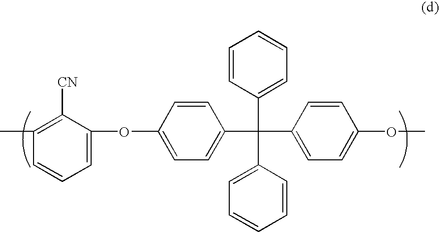

The thus-obtained polymer showed the following IR peak.

2250 cm⁻¹ (CN)

(2) Synthesis of Block Copolymer

A block copolymer of the above formula (D) was obtained by carrying out a reaction and post treatment in the same manner as in Example 11(2) except that the raw materials in Example 11(2) were replaced with 2.782 g (0.02 mol) of 2,6-difluorobenzonitrile, 3.424 g (0.015 mol) of potassium 2,5-dihydroxybenzenesulfonate, 1.762 g (0.005 mol) of bis(4-hydroxyphenyl)diphenylmethane and 2.544 g (0.024 mol) of sodium carbonate and that the polymer added in the copolymerization was replaced with 1.13 g (0.0025 mol) of the polymer obtained in Example 14(1).

The thus-obtained block copolymer had a molecular weight of 135,000, and its IR peaks were as follows.

1,160, 1,390 cm⁻¹ (SO₃H), 2,250 cm⁻¹ (CN)

### Example 15

(1) Synthesis of Homopolymer

A polymer having the following recurring unit (e) was obtained by carrying out a reaction in the same manner as in Example 11(1) except that 5.034 q (0.0198 mol) of 4,4′-difluorodiphenyl sulfone was replaced with 2.754 g (0.0198 mol) of 2,6-difluorobenzonitrile, that 4.566 g (0.02 mol) of bisphenol A was replaced with 3.724 g (0.02 mol) of 4,4′-dihydroxybiphenyl and further that that 3.317 g (0.024 mol) of potassium carbonate was replaced with 2.544 g (0.024 mol) of sodium carbonate.

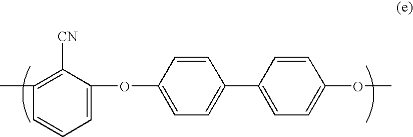

The thus-obtained polymer showed the following IR peak.

2250 cm⁻¹ (CN)

(2) Synthesis of Block Copolymer

A block copolymer of the above formula (E) was obtained by carrying out a reaction and post treatment in the same manner as in Example 11(2) except that the raw materials in Example 11(2) were replaced with 2.782 g (0.02 mol) of 2,6-difluorobenzonitrile, 3.424 g (0.015 mol) of potassium 2,5-dihydroxybenzenesulfonate, 0.931 g (0.005 mol) of 4,4′-dihydroxybiphenyl and 2.544 g (0.024 mol) of sodium carbonate and that the polymer added in the copolymerization was replaced with 0.71 g (0.0025 mol) of the polymer obtained in Example 15(1).

The thus-obtained block copolymer had a molecular weight of 110,000, and its IR peaks were as follows.

1,160, 1,390 cm⁻¹ (SO₃H), 2,250 cm⁻¹ (CN)

### Example 16

(1) Synthesis of Homopolymer

A polymer having the following recurring unit (f) was obtained by carrying out a reaction in the same manner as in Example 11(1) except that 5.034 g (0.0198 mol) of 4,4′-difluorodiphenyl sulfone was replaced with 4.321 g (0.0198 mol) of 4,4′-difluorobenzophenone.

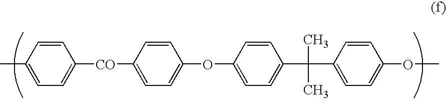

(2) Synthesis of Block Copolymer

A block copolymer of the above formula (F) was obtained by carrying out a reaction and post treatment in the same manner as in Example 11(2) except that the raw materials in Example 11(2) were replaced with 4.364 g (0.02 mol) of 4,4′-difluorobenzophenone, 3.424 g (0.015 mol) of potassium 2,5-dihydroxybenzenesulfonate, 1.142 g (0.005 mol) of bisphenol A and 3.317 g (0.024 mol) of potassium carbonate and that the polymer added in the copolymerization was replaced with 1.02 g (0.0025 mol) of the polymer obtained in Example 16(1).

The thus-obtained block copolymer's IR peaks were as follows.

1,160, 1,390 cm⁻¹ (SO₃H)

### Example 17

(1) Synthesis of Homopolymer

A polymer having the following recurring unit (g) was obtained by carrying out a reaction in the same manner as in Example 11(1) except that 4.566 g (0.02 mol).of bisphenol A was replaced with 3.724 g (0.02 mol) of 4,4′-dihydroxybiphenyl.

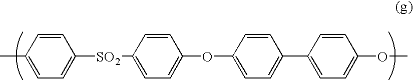

(2) Synthesis of Block Copolymer

A block copolymer of the above formula (G) was obtained by carrying out a reaction and post treatment in the same manner as in Example 11(2) except that the raw materials in Example 11(2) were replaced with 5.085 g (0.02 mol) of 4,4′-difluorodiphenyl sulfone, 3.464 g (0.01 mol) of 4,4′-dihydroxy-2,2′-disulfonic acid-1,1′-biphenyl, 1.862 g (0.01 mol) of 4,4′-dihydroxybiphenyl and 3.317 g (0.024 mol) of potassium carbonate and that the polymer added in the copolymerization was replaced with 2.00 g (0.005 mol) of the polymer obtained in Example 17(1).

The thus-obtained block copolymer had a molecular weight of 63,500, and its IR peaks were as follows.

1,160, 1,390 cm⁻¹ (SO₃H)

### Example 18

(1) Synthesis of Homopolymer

A polymer having the above unit (e) was obtained by carrying out a reaction in the same manner as in Example 15(1).

(2) Synthesis of Block Copolymer

A block copolymer of the above formula (H) was obtained by carrying out a reaction and post treatment in the same manner as in Example 11(2) except that the raw materials in Example 11(2) were replaced with 2.782 g (0.02 mol) of 2,6-difluorobenzonitrile, 3.464 g (0.01 mol) of 4,4′-dihydroxy-2,2′-disulfonic acid-1,1′-biphenyl, 1.862 g (0.01 mol) of 4,4′-dihydroxybiphenyl and 2.544 g (0.024 mol) of sodium carbonate and that the polymer added in the copolymerization was replaced with 1.42 g (0.005 mol) of the polymer obtained in Example 18(1).

The thus-obtained block copolymer had a molecular weight of 77,000, and its IR peaks were as follows.

1,160, 1,390 cm⁻¹ (SO₃H), 2,250 cm⁻¹ (CN)

### Example 19

(1) Synthesis of Homopolymer

A polymer having the following unit (h) was obtained by carrying out a reaction in the same manner as in Example 11(1) except that 4.566 g (0.02 mol) of bisphenol A was replaced with 7.009 (0.02 mol) of 9,9-bis(4-hydroxyphenyl)fluorene.

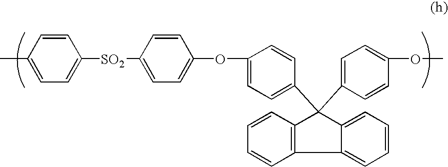

(2) Synthesis of Block Copolymer

A block copolymer of the above formula (I) was obtained by carrying out a reaction and post treatment in the same manner as in Example 11(2) except that the raw materials in Example 11(2) were replaced with 5.085 g (0.02 mol) of 4,4′-difluorodiphenyl sulfone, 3.464 g (0.01 mol) of 4,4′-dihydroxy-2,2′-disulfonic acid-1,1′-biphenyl, 3.504 g (0.01 mol) of 9,9-bis(4-hydroxyphenyl)fluorene and 3.317 g (0.024 mol) of potassium carbonate and that the polymer added in the copolymerization was replaced with 2.82 g (0.005 mol) of the polymer obtained in Example 19(1).

The thus-obtained block copolymer had a molecular weight of 92,000, and its IR peaks were as follows.

1,160, 1,390 cm⁻¹ (SO₃H)

### Evaluation Examples

(1) Measurement of Sulfur Content

The sulfur contents of the polymers obtained in Examples were measured with a carbon/sulfur analyzer LECO CS-444. Specifically samples of the polymers were burned with high frequency waves to generate sulfur oxides. The amount of the sulfur oxides was determined by the infrared absorption method. Table 1 shows the results.

(2) Calculation of Content of Sulfonic Acid Group

The calculation method will be described referring to Example 6.

(2) Preparation of Cast Film

One gram of the copolymer obtained in one of Examples 1 to 20 was dissolved in 9 g of N-methylpyrrolidone, and the resultant solution was cast on a glass plate to form a film having a thickness of 40 μm. Under nitrogen current, the film was dried at 80° C. for 4 hours, and then under reduced pressure, it was dried at 100° C. for 8 hours. In this manner, cast films formed of the copolymers obtained in Examples 1 to 20 were obtained.

(3) Measurement of Water Content

Excess water on each film surface was wiped off, and each film was measured for a wet weight (W_{wet}). Then, these films were dried in a dryer set at 130° C. for 12 hours, to vaporize water in -the films. Further, each film was measured for a dry weight (W_{dry}). On the basis of these results, water contents (W_{H2O}) were determined according to the following equation.
(W_{H2O}) (%)=(W_{wet}−W_{dry})/(W_{wet})

Table 1 shows the results.

(4) Measurement of Film Resistance

A film resistance (specific resistance) was measured according to an AC four-terminal method. An apparatus had an impedance analyzer and a film resistance measuring cell, and a 0.5 M-HCL solution was used as a measurement solution. The measurement cell was constituted of a cell having a pair of titanium electrodes (electrode area 1.0 cm²) whose surfaces were black-plated with platinum and a base for supporting the cell. The electrodes were 3.0 mm distant from each other when no film was set.

The measurement procedure are as shown below.

1) A sample equilibrated in the 0.5 M-HCl solution was sandwiched between the two film resistance measurement cell electrodes.

2) AC was applied at a frequency of 10 to 1 MHz with an impedance analyzer, to measure a conductance G[S] and a susceptance B[S]. After the measurement, the solution between the electrodes was measured for an electric resistance R_{blank} [Ω].

3) The conductance G[S] and the susceptance B[S] obtained by the measurement were substituted in the following equation to calculate a resistance R [Ω], and values obtained at 100 to 10 kH were averaged, and an obtained average was used as a film resistance R [Ω].
R=1/G×D²/(1+D²), D=tan δ=G/B

4) On the basis of the electric conductivity κ [Sm-1] of the 0.5 M-HCl solution used for the measurement, the resistance value R_{blank} [Ω] of the solution obtained by the measurement in a state where no film was sandwiched, and the inter-electrode distance, an effective film area S [cm²] of the electrodes was determined according to the following equation. d represents a film thickness [cm].
S=d/κ×R_{blank}

5) The film resistance R [Ω], the resistance R_{blank} [Ω] of the solution, the effective film area S [cm²] and the film thickness d [cm] were substituted in the following equation, to determine a specific resistance p [Ω cm] of the film.
ρ=(R−R_{blank})×S/d

Table 1 shows the measurement results.

(5) Measurement of Methanol Permeability

A film was placed between a solution (supply side) of an aqueous solution having a methanol concentration of 20 vol % and a solution (permeation side) of pure water, and methanol was allowed to diffuse into a permeation side with the passage of time. The pure water side was evaluated for a methanol concentration, and a film that caused a less change in the methanol concentration with the passage of time was evaluated to have the superior property of inhibiting the permeation of methanol. The evaluation method will be specifically described below.

1) The mixture solution on the supply side was measured for methanol concentrations, and the permeation side was measured for methanol concentrations, eight times for a total time period of 8 hours at intervals of 1 hour with a capillary gas chromatograph.

2) A parameter P for a methanol permeation coefficient was calculated from these values by substitutions into the following equation.
P=d/SCM
wherein d is a film thickness [cm], S is an area [cm²] of the portion of a container that was in contact with the film, C is an amount of change in methanol concentration [vol %] with measurement time [sec], and M is a volume [cm³] of the container.

Table 1 shows the measurement results.

Table 1 also shows data of an existing product, Nafion (registered trademark) 115, for reference.

TABLE 1

| | Poly- | | | | Film | MeOH |
|---|---|---|---|---|---|---|
| | meri- | Struc- | S | | resis- | permeability |
| Exam- | zation | tural | content | Water | tance | (10⁻⁶ cm²/ |
| ple | type | formula | (wt %) | content | (Ω · cm) | sec) |
| 1 | Random | A | — | 14 | 43 | 2.0 |
| 2 | | A | — | 24 | 13 | — |
| 3 | | B | — | 25 | 74 | 1.9 |
| 4 | | C | 6.1 | 24 | 17 | 2.2 |
| 5 | | D | 5.2 | 32 | 37 | 2.4 |
| 6 | | E | 6.6 | 45 | 9 | 2.8 |
| 7 | | F | 4.9 | 30 | 60 | — |
| 8 | | G | — | 20 | 30 | — |
| 9 | | H | 7.0 | 23 | 23 | — |
| 10 | | I | — | 25 | 28 | — |
| 11 | Block | A | — | 5 | 20 | 3.1 |
| 12 | | B | — | 20 | 33 | — |
| 13 | | C | 6.1 | 15 | 31 | 2.0 |
| 14 | | D | 5.3 | 26 | 17 | 1.8 |
| 15 | | E | 6.4 | 34 | 12 | 1.7 |
| 16 | | F | — | 25 | 50 | — |
| 17 | | G | — | 18 | 28 | — |
| 18 | | H | 6.9 | 20 | 18 | 2.2 |
| 19 | | I | — | 23 | 28 | — |

| | | | |
|---|---|---|---|
| Nafion 115 | 25 | 20 | 26 |

The invention is based on Japanese Patent Application No. 2004-008817, the entire content of which is herein incorporated by reference.

1. A polyaryl ether copolymer which has the following formula (1) and contains at least 0.1% by weight of a hydrophilic group,
Ar₁—O—Ar₂—OₙAr₃—O—Ar₄—Oₘ (1)
wherein each of Ar₁ and Ar₃ independently represents a group selected from the following groups, 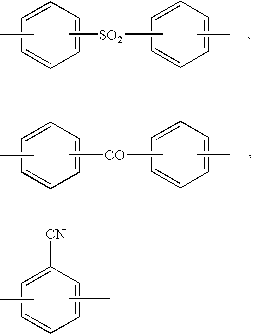
each of Ar₂ and Ar₄ independently represents a group selected from the following groups, 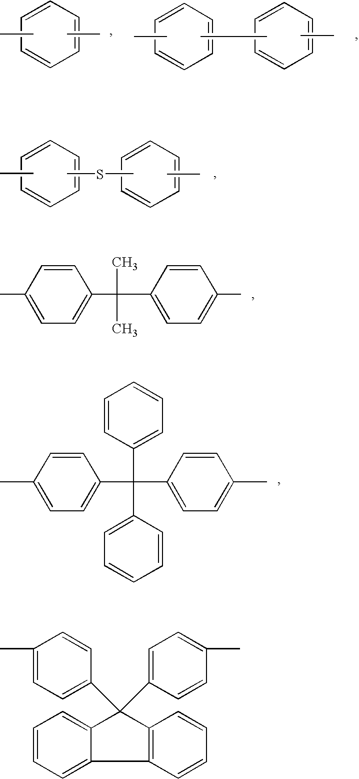
the hydrophilic group is substituted on at least one of Ar₁, Ar₂, Ar₃ and Ar₄, and each of n and m represents a copolymerization compositional ratio.

2. The polyaryl ether copolymer of claim 1, wherein Ar₁ is a cyanophenylene group.

3. The polyaryl ether copolymer of claim 1, wherein Ar₁ and Ar₃ represent the same groups.

4. The polyaryl ether copolymer of claim 1, wherein the hydrophilic group is at least one group selected from a sulfonic acid group (—SO₃H), a phosphonic acid group (—PO₃H₂) or a carboxyl group (—COOH).

5. The polyaryl ether copolymer of claim 4, wherein the hydrophilic group is a sulfonic acid group (—SO₃H).

6. The polyaryl ether copolymer of claim 1, which is a random copolymer.

7. The polyaryl ether copolymer of claim 1, which is a block copolymer.

8. A process for the production of the polyaryl ether copolymer of claim 1, which comprises copolymerizing X—Ar₁—X, HO—Ar₂—OH, X—Ar₃—X and HO—Ar₄—OH, in which X is a halogen, Ar₁, Ar₂, Ar₃ and Ar₄ are as defined above, and a hydrophilic group is substituted on at least one of Ar₁, Ar₂, Ar₃ and Ar₄.

9. A process for the production of a polyaryl ether random copolymer of claim 3, which comprises reacting X—Ar₁—X, HO—Ar₂—OH and HO—Ar₄—OH, in which X is a halogen, Ar₁, Ar₂ and Ar₄ are as defined above, and a hydrophilic group is substituted on at least one of Ar₁, Ar₂ and Ar₄.

10. A process for the production of a polyaryl ether block copolymer of claim 3, which comprises reacting X—Ar₁—X and HO—Ar₄—OH to produce a polymer and adding the polymer when X—Ar₁—X, HO—Ar₂—OH and HO—Ar₄—OH are reacted to form a random copolymer, in which X is a halogen, Ar₁, Ar₂ and Ar₄ are as defined above, and a hydrophilic group is substituted on at least one of Ar₁, Ar₂ and Ar₄.

11. A polymer electrolytic film formed of the polyaryl ether copolymer of claim 1.

12. An electrode material formed of the polyaryl ether copolymer of claim 1.

13. A fuel cell comprising the polymer electrolytic film of claim 11.

14. A fuel cell comprising the electrode material of claim 12.
